(19) United States
(12) Patent Application Publication
(10) Pub. No.: US 2011/0101146 A1
(43) Pub. Date: May 5, 2011

(54) Winding Device for Cables Connecting Electric or Electronic Equipments with Instruments

(76) Inventor: Riccardo Bordignon, Cassola (VI) (IT)

(21) Appl. No.: 11/910,080

(22) PCT Filed: Apr. 5, 2005
(86) PCT No.: PCT/IT2005/000183

§ 371 Date: Jun. 1, 2009

(51) Int. Cl. H02G 11/02; B65H 75/06; B65H 75/40; B65H 75/44

(52) U.S. Cl. 242/405.2; 242/613

(57) ABSTRACT

A winding device for the connecting cables of electric and/or electronic equipment and/or instruments comprising a frame which mainly extends according to a longitudinal axis of symmetry and in which there is a pair of first housings positioned opposite one another, which hold the cable, and second housings which hold the jacks connected to the ends of the cable.

The present invention relates to a winding device for the connecting cables of electric and/or electronic equipment and/or instruments, in particular for those coaxial electric cables used by musicians to connect an electric musical instrument, for example an electric guitar, to an amplification system.

As is known, musicians, whether soloists or members of a band, use cables to connect their instruments, for example an electric or acoustic guitar, to a system which amplifies the sound produced by the vibration of parts of the musical instruments impressed by the musicians.

The ends of such cables have special connectors or plugs, commonly known as “jacks” in English, with two or more coaxial wires. The jacks are coupled to suitable sockets present both on the musical instrument and on an electric or electronic device belonging to the amplification system.

When musicians have finished using the musical instrument, for example after a concert, they disconnect the cables from the instrument and from the amplification system and wind them until they take on a configuration which occupies the minimum space possible and makes them easy to move.

Various techniques are currently used to wind said cables, some of them well known and normally adopted for winding a generic electric cable. The most classic but also the most empirical method consists in manually winding the cable in a number of irregular concentric rings to form a sort of coil, which remains free of any constraints for holding it stable in any way in that position.

For this purpose, other known solutions involve the use of elastic bands, having coupling means on the ends so that they can be closed in a loop and secured around the cable just wound.

Obviously, the techniques described above lead to the acknowledged disadvantage of keeping the cable wound in a configuration that is almost always untidy, with all of the disadvantages that this brings, linked on one hand to its effective repositioning and on the other hand to the possibility that accidental impacts of various types may seriously or irreparably damage the jacks at the ends, which as is known is quite a delicate matter due to their cost. These disadvantages were partly overcome by introducing more professional cable winding systems based on the use of a metal frame, with wheels for its movement, and a drum, whose rotation is driven by a handle for the user, and around which one or more cables are wound, even very long cables, for example around 500 m and more.

More typically, the above-mentioned frames are used by more famous musicians or bands, with a certain number of members or who use a moderate number of electric or electronic musical instruments.

However, even these do not overcome the disadvantage of having to protect the jacks at the ends of the cables wound around the drum and, therefore, it remains possible that their sudden movement may result in accidental impacts against other bodies or objects that will damage the cables.

On the other hand, there are cable winding devices available on the market which comprise a drum around which one or more cables are wound, a grip for the operator for lifting and moving, and a shaped base for practical standing on any surface, for example the floor or the stage on which bands or individual musicians perform during their concerts.

The drum is located between a pair of flanges on the outer surface of which there is a plurality of sockets suitable to hold the jacks present at the ends of the above-mentioned cables.

This at least partly overcomes the above-mentioned disadvantages, deriving from the free position of the cable jacks when the cables are wound in any way.

However, in this case too, the jacks remain partly projecting from the flanges connected to the drum on which the cable is wound, and therefore, the possibility that accidental impacts against bodies or objects during the movement causes damage on them is not completely avoided.

Moreover, said device, like the one previously described, has considerable dimensions which are a negative factor above all where there is a high density of electric or electronic instruments or equipment, for example on a stage where a band is playing, constituting an unwanted obstacle.

In addition to this, to justify the use of such a device more than one cable needs to be wound around the drum, having a negative consequence because the weight that the user must support when moving the device is considerable. Another disadvantage derives from the fact that such devices for winding cables are not suitable for use by private users, such as youngsters who play an electric guitar as a hobby, for example in rooms in their own homes, therefore leaving the problem of safely storing the cables when not in use. The present invention aims to overcome the above-mentioned disadvantages in the prior art.

In particular, the main aim of the invention is to provide a winding device for the connecting cables of electric and/or electronic equipment and/or instruments which allows the jacks connected at the ends of the cables to be protected more effectively than by known equivalent devices.

A second aim of the invention is to make connecting cable winding and unwinding more rapid and easier for the musician than with the prior art.

Another aim of the invention is to provide a winding device that is simpler to produce than known winding devices.

Yet another aim of the invention is to provide a winding device which is easier to transport than known winding devices.

A further aim of the invention is to allow any musician, even a youngster who as a hobby plays a musical instrument at home, for example an electric guitar, to wind the connecting cable in an efficient and practical way, safeguarding the integrity of the jacks at the ends of the cable, without the need to purchase a professional device, more suitable for professional musicians or bands and, as already indicated, large and designed to support a plurality of cables.

These aims are achieved by a winding device for the connecting cables of electric and/or electronic equipment and/or instruments which, in accordance with the main claim, is characterised by comprising a frame which mainly extends according to a longitudinal axis of symmetry and in which there is a pair of first housings located opposite one another, suitable to hold said cable, and one or more second housings, suitable to hold the jacks connected to at least one of the ends of said cable.

Advantageously, the invention provides a protection for the jacks at the ends of the cables which is more suitable and effective than the equivalent prior art. Also advantageously, the invention offers any musician, even a youngster who, privately or with a group of friends, plays a musical instrument as a hobby, the possibility of appropriately winding the cable which connects their musical instrument to an amplification system.

Equally advantageously, the winding device disclosed has a simpler design than the winding devices used for the same purposes in the prior art.

Moreover, the winding device can be moved in an extremely practical and easy way even when the cable is wound on it, thanks to its lightness in particular resulting from the fact that it is preferably made of plastic.

The above-mentioned aims and advantages, and others described in detail in this patent, are more apparent in the description of the preferred embodiments of the invention without limiting the scope of its application, with reference to the accompanying drawings, in which:

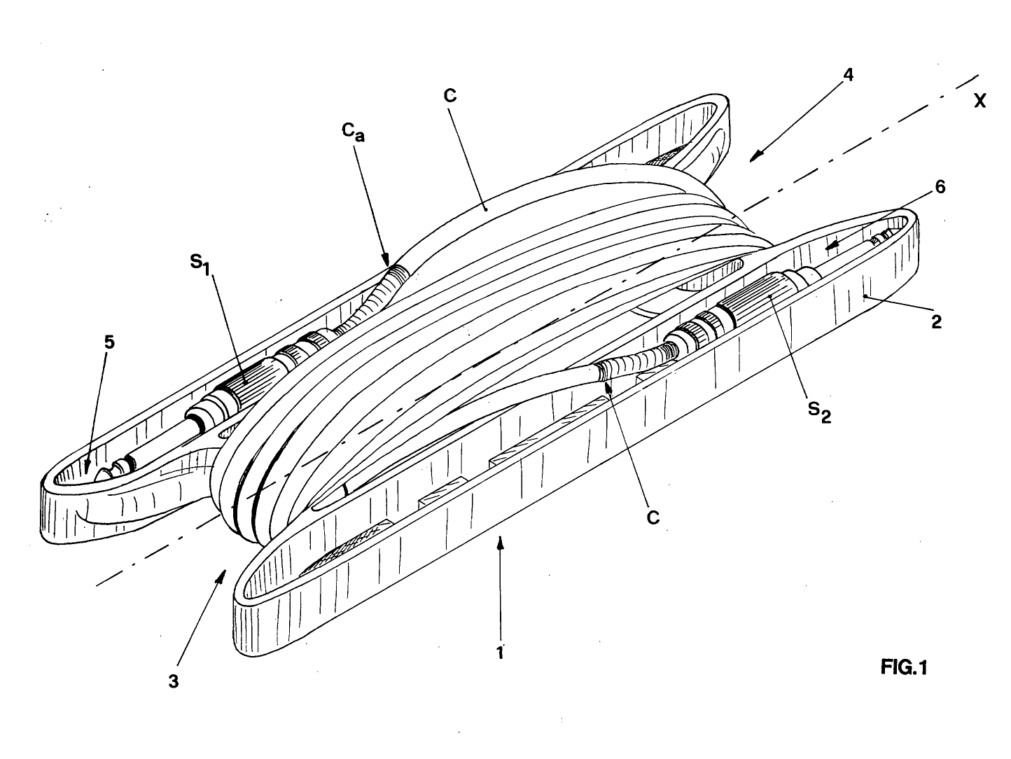

FIG. 1 is an axonometric view of the winding device according to the invention complete with connecting cable;

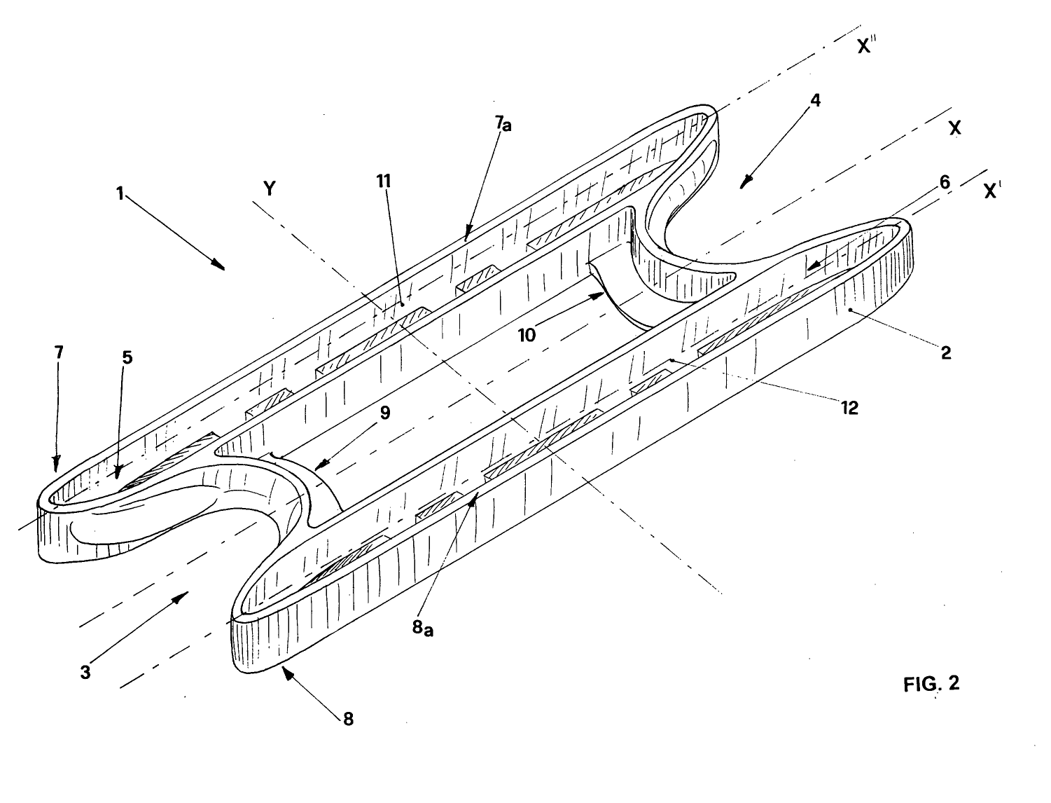

FIG. 2 is a view of the winding device illustrated in FIG. 1 without the cable;

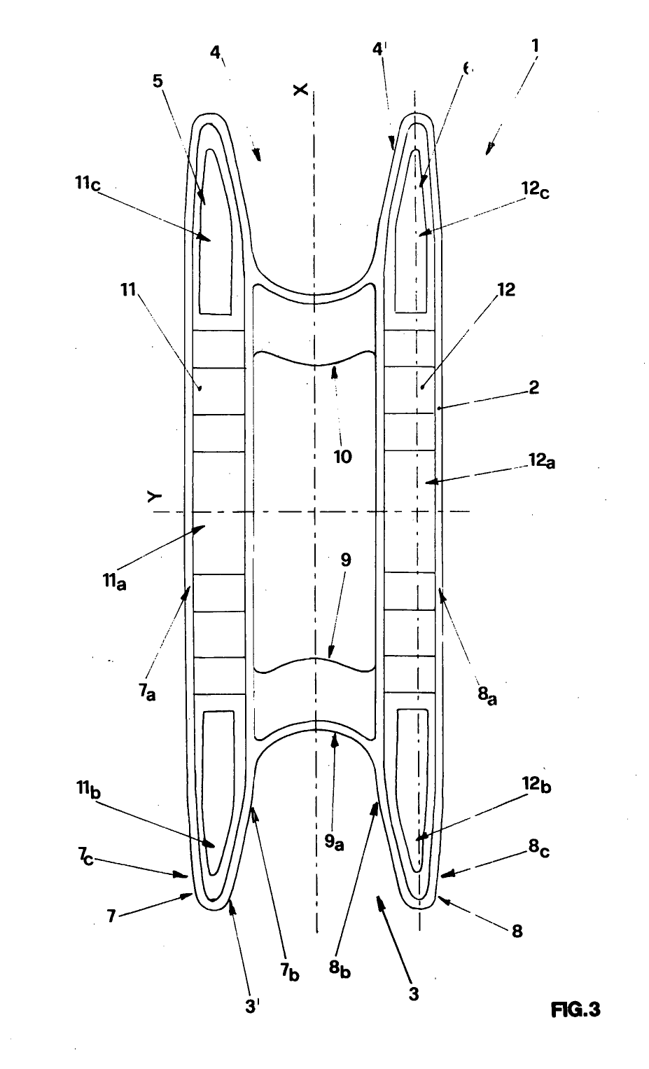

FIG. 3 is a side view of FIG. 2;

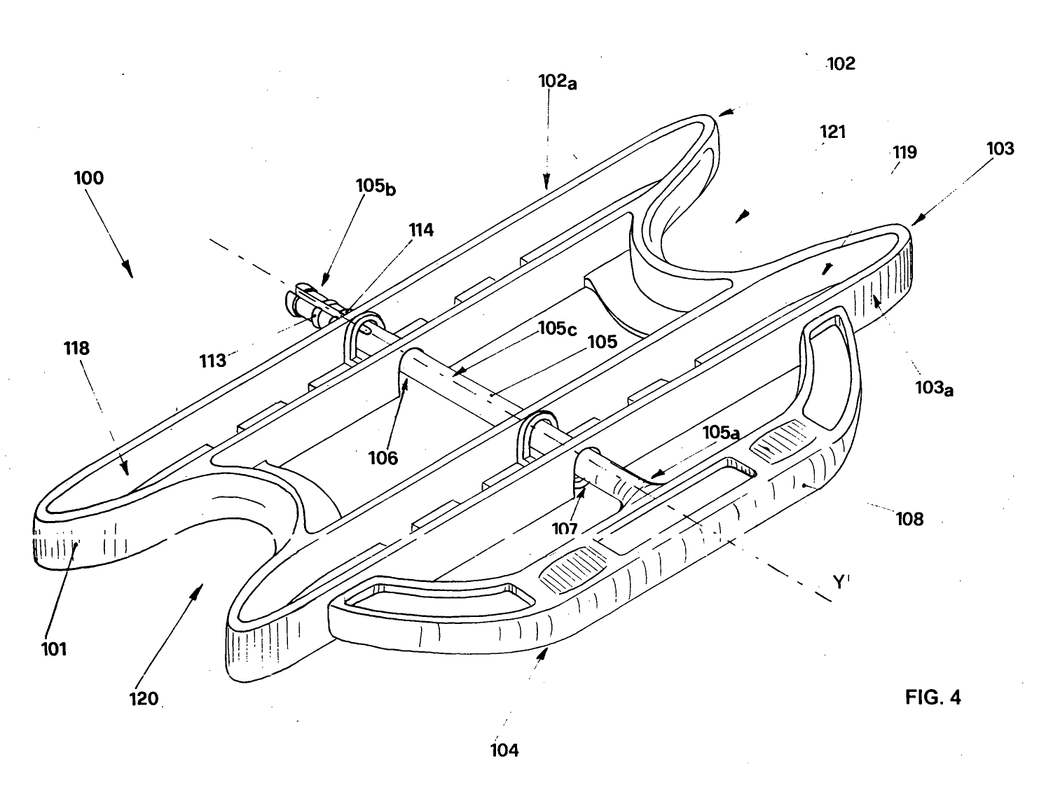

FIG. 4 is an axonometric view of an alternative embodiment of FIG. 2;

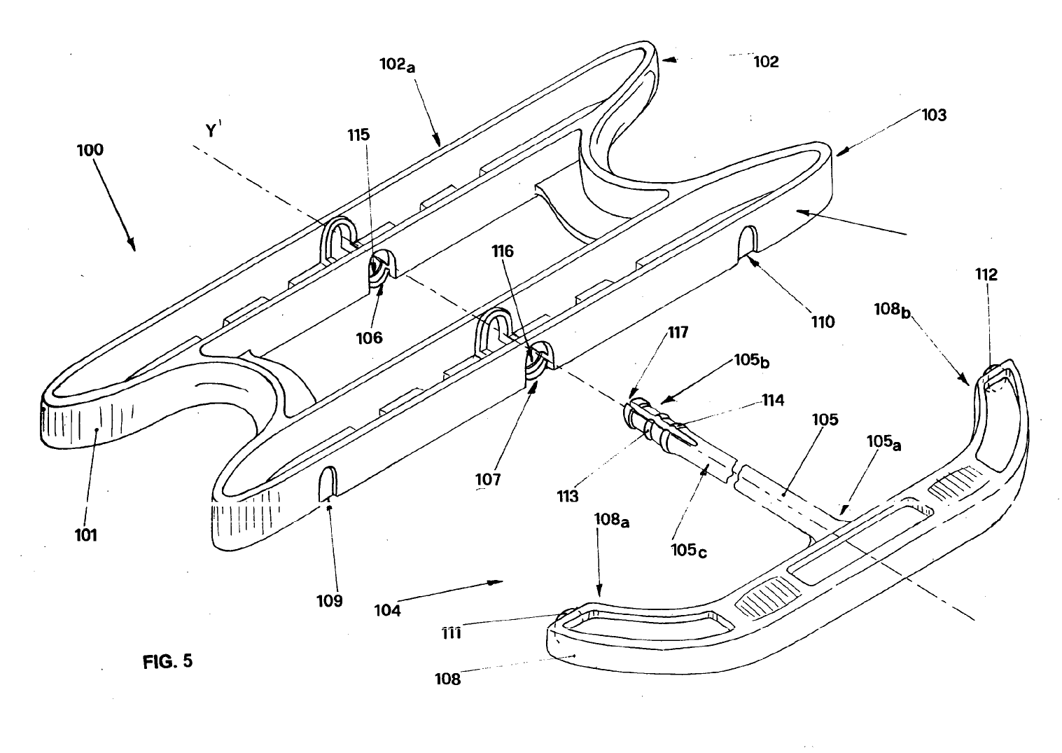

FIG. 5 is an exploded view of FIG. 4;

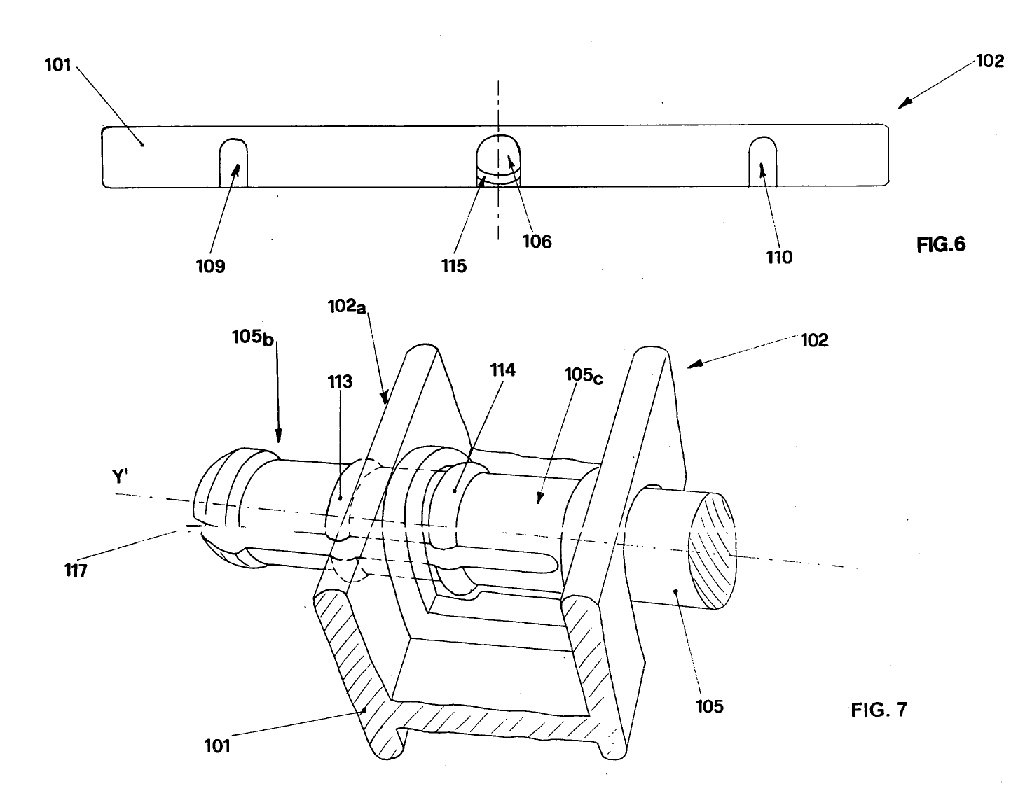

FIG. 6 is a side view of FIG. 5;

FIG. 7 is an enlarged view of a detail illustrated in FIG. 4 in a possible operating condition.

The winding device disclosed is illustrated in FIG. 1, and indicated by 1 as a whole, to which a connecting cable C for electric and/or electronic equipment and/or instruments is connected, for example a cable for connecting a musical stringed instruments, such as an electric guitar, to an amplification system. According to the invention, the winding device 1 comprises a frame 2 which extends mainly according to a longitudinal axis of symmetry X and in which there is a pair of first housings 3, 4 located opposite one another, which hold the cable C, and two second housings 5, 6 which hold the jacks S₁, S₂ connected to each of the ends Cₐ, C_{b} of the cable C.

The special nature of the winding device 1 disclosed can be seen from FIG. 1.

It consists of the creation of the first housings 3, 4 and, above all, the second housings 5, 6 which allow the cable C to be suitably supported and also effectively protect the jacks S₁, S₂ connected to it, since each jack is completely held by snapping into one of the second housings 5, 6, as described in more detail below.

When the cable C is in the conditions illustrated in FIG. 1, wound around the winding device 1, the jacks S₁, S₂, indeed, are protected by the frame 2 inside the housings 5, 6, and, therefore, any accidental impact, caused by sudden winding device 1 movements, is absorbed by the frame 2 without causing any damage to the jacks S₁, S₂, as occurs with the known type of winding device. FIG. 2 shows how the frame 2, made of plastic, preferably with fibreglass, substantially extends according to a plane containing the longitudinal axis of symmetry X.

Moreover, the frame 2 consists of two ribs 7, 8 set opposite one another and with respective longitudinal axes X′, X″ parallel with one another and with the axis of symmetry X of the frame 2.

The two ribs 7, 8 are positioned symmetrically relative to the longitudinal axis of symmetry X of the frame 2 and are connected to one another close to the intermediate zone by transversal elements 9, 10 set opposite one another, forming for the frame 2 an essentially H-shaped profile, better illustrated in FIG. 3.

The transversal elements 9, 10 are in turn positioned symmetrically relative to the central axis Y of the frame 2, orthogonal to the longitudinal axis of symmetry X, giving the frame 2 a shape with double symmetry.

It should be noticed that each of the first housings 3, 4 has a substantially U-shaped profile 3′, 4′.

Hereinafter and unless otherwise indicated, for the sake of clarity reference is only made to the first housing indicated by 3, although what is said also applies to the first housing indicated by 4.

The profile 3′ is formed by the inner surfaces 7b, 8b, positioned opposite one another, of the ribs 7, 8, comprised between the ends 7c, 8c of the ribs 7, 8 themselves and the transversal element 9 and constituting the sides of the U-shaped profile, as well as by the outer surface 9a of the transversal element 9, which forms the base of the U-shaped profile.

Each of the inner surfaces 7b, 8b of the ribs 7, 8 is tapered according to a direction incident upon the longitudinal axis X′, X″ of each of the ribs 7, 8. As regards the second housings 5, 6, FIG. 2 and FIG. 3 show that they consist of a lowered zone 11, 12 made on the lateral wall 7a, 8a of each of the ribs 7, 8.

Obviously, in other embodiments of the invention, not illustrated, the lowered zones which form the second housings may be made on both of the lateral walls of the ribs, offering the possibility of coupling the cable jacks irrespectively on one face or the other of the winding device frame. The lowered zone 11, 12 has a main section 11a, 12a with a constant profile and tapered ends 11 b and 11c, 12b and 12c.

The construction device described for the lowered zones 11, 12 substantially reproduces the shape of the jacks S₁, S₂ which they must hold, typically consisting of more coaxial wires, the innermost projecting from the one immediately outside it.

FIG. 4 illustrates an example of an alternative embodiment of the invention, in which the winding device, indicated by 100 as a whole, differs from that described with reference to FIGS. 1 to 3 because it comprises rotation and support means, indicated by 104 as a whole, available to the operator and consisting of:
a plastic shaft 105, removably inserted in through-holes 106, 107 coaxial with one another according to the central axis Y′ of the frame 101 and made in each of the ribs 102, 103;
a handle 108, also made of plastic, preferably but not necessarily in a single body with the shaft 105, connected to a first end 105a of the shaft 105 itself.

As illustrated in FIGS. 5 and 6, at the lateral edge 102a, 103a, the ribs 102, 103 have a pair of recesses 109, 110, each suitable to hold a projection 111, 112 present at the ends 108a, 108b of the handle 108 to prevent frame 101 rotation around the central axis Y′ in rest conditions or when not used.

In other embodiments of the winding device disclosed, not illustrated, the recesses may be made only at the lateral edge of one of the two ribs forming the frame.

In such a case, the rotation and support means may be connected to the frame only on one side, unlike the winding device 100 in which the rotation and support means 104 may be connected to the frame 101 both on the side of the rib 102 and on the side of the rib 103.

Moreover, alternative embodiments of the invention, not illustrated, may have a single recess on the lateral edge of at least one of the ribs and obviously a single corresponding projection at one end of the handle.

FIGS. 4 and 5 also illustrate how the shaft 105 has, on the lateral surface 105c, at a second end 105b opposite the first end 105a, a pair of ring-shaped prominences 113, 114 projecting from the lateral edge 102a of the rib 102 when the frame 101 supports the cable in rest conditions.

As is described in more detail below, the innermost of the ring-shaped prominences 113, 114, in the case in question the one indicated by 114, is positioned close to a shoulder 115, visible in FIGS. 5 and 6, made in the through-hole 106, to allow the frame 101 to turn around the central axis Y′ and, for example, to unwind the cable, releasing it from the frame 101.

The through-hole 107 of the rib 103 also has a similar shoulder 116, close to which the ring-shaped prominence 113 is positioned when the shaft 105 is coupled to the frame 101 on the side opposite that illustrated in the accompanying drawings, that is with the handle 108 facing the lateral edge 102a of the rib 102.

FIG. 5 shows how the second end 105b of the shaft 105 has a diametral cut 117 which makes it elastically yielding, an extremely important detail when the frame 101 has to be turned around the central axis Y′.

It should be noticed that in other embodiments of the invention, not illustrated, the lateral surface of the shaft of the rotation and support means may have contrast means which, when already coupled to the frame, prevent its accidental separation while it is in the user's hands.

In operating conditions, the musician transports the cable C on the winding device 1 in a practical and easy way, with the guarantee that the jacks S₁, S₂ are fixed in position inside the second housings 5, 6 and protected from any accidental impacts.

When he wants to use the cable C, the musician releases the jack S₁, connected to the end Cₐ of the cable C, from the second housing 5 and snaps it in the respective socket, present, for example, in the musical instrument or in a device belonging to the amplification system.

Then, gripping the frame 1 with one hand, he uses the other hand to unwind the entire cable C until the jack S₂, connected to the end C_{b} of the cable C, is released from the second housing 6 in order to be plugged into the appropriate socket, that of the device belonging to the amplification system or that of the musical instrument.

When the musician has finished using the cable C, he removes the jacks S₁, S₂ from the relative instruments and devices and snaps one of the two jacks in one of the second housings 5, 6, then winding the cable C on the frame 2, arranging it in the first housings 3, 4 until one of the ends Cₐ, C_{b} of the cable C remains free, the other jack S₁, S₂ being connected to the cable C and being thus snapped into the other second housings 5, 6.

For the winding device 100, the musician or other authorised person acts similarly to wind the cable around the frame 101.

A first jack, connected to one end of the cable, is inserted by snapping in the second housing 118, then the user with one hand winds the cable around the frame 101 so that it is held in the first housings 120, 121 until the opposite end of the cable with the corresponding jack remains free and said jack is inserted by snapping in the second housing 119.

However, in this case, cable unwinding is rather different to that of the winding device 1 due to the presence of the rotation and support means 104 that can be accessed by the musician or by the authorised user; which make it extremely easy.

These rotation and support means 104 are arranged according to the configuration illustrated in FIG. 4 when the cable is wound on the winding device 100 or when the latter is in conditions in which it is not used. In this operating condition, the projection 111, 112 at the ends 108a, 108b of the handle 108 is coupled to the corresponding recesses 109, 110 in the lateral edge 103a of the rib 103, the shaft 105 is inserted in the through-holes 106, 107 and the end 105b of the shaft projects from the lateral edge 102a of the rib 102 so that the ring-shaped prominences 113, 114 are outside the rib 102 itself.

To unwind the cable from the winding device 100, the musician or user pulls the handle 108, releasing the projection 111, 112 from the recesses 109, 110 and positioning only the ring-shaped prominence 114 close to the shoulder 115 present in the through-hole 106 of the rib 102.

The other ring-shaped prominence 113 projects from the lateral edge 102a of the rib 102, according to the configuration illustrated in FIG. 7.

In this way, the frame 101 is free to turn around the central axis Y′, allowing the practical and rapid cable unwinding from the winding device.

When the user pulls the handle 108, the diametral cut 117 at the second end 105b of the shaft 105 makes it elastically yielding and allows fluid sliding of the shaft 105 along the central axis Y in the through-holes 106, 107 and, at the same time, creation of an effective seal between the shaft 105 and the frame 101 as soon as the desired position is reached.

When the shaft 105 is positioned in the operating condition as illustrated in FIG. 7, the user removes the jack connected to a first end of the cable, unwinds the cable by turning the frame 101 around the central axis Y′, said movement resulting from simply pulling the cable and, finally, also releases the jack present at the second end of the cable.

Obviously, in other use situations, the musician may couple the shaft 105 to the frame 101 on the side opposite that illustrated in the accompanying drawings, positioning the handle 108 close to the lateral edge 102a of the rib 102 and the second end 105b of the shaft 105 projecting from the lateral edge 103a of the rib 103.

Therefore, the winding device disclosed allows improved and more effective protection than known equivalent winding devices for the jacks connected to the connecting cables of electric and/or electronic equipment and/or instruments.

It is suitable for winding preferably one cable and, therefore, it is also suitable for purchasing by private users, for example a youngster who plays a musical instrument as a hobby, such as an electric guitar, this fact distinguishing it from the winding devices in the prior art which, due to their construction, are aimed at bands or musicians who have a considerable number of musical instruments.

The winding device disclosed is produced by simply injection moulding of plastic material and, as a result, has a production and marketing cost which makes it attractive on the market.

Therefore, based on the above description, it is evident that the winding device for the connecting cables of electric and/or electronic equipment and/or instruments disclosed achieves all of the afore-mentioned aims and provides all of the advantages mentioned.

During production, modifications may be made to the winding device disclosed, for example consisting of a different frame shape.

In addition, there may be alternative embodiments in which the frame material is different from that mentioned above, without invalidating the advantage brought by the present patent.

All of the embodiments described and referred to, but not illustrated in the accompanying drawings, where they do not depart from the inventive concept described in the claims herein, must be considered protected by this patent.

1. A winding device for the connecting cables of electric and/or electronic equipment and/or instruments comprising a frame which mainly extends according to a longitudinal axis of symmetry of the frame and consists of two ribs set opposite one another and connected to one another close to the intermediate zone by transversal elements positioned opposite one another and giving said frame an essentially H-shaped profile, in said frame being present a pair of first housings positioned opposite one another, being suitable to hold the cable, and two or more second housings suitable to hold the jacks connected to at least one of the ends of said cable, wherein each of said second housings consists of a lowered zone, created on at least one lateral wall of each of said ribs, within which said jacks may be received by means of a snap-fit.

2. The winding device according to claim 1, wherein said frame extends mainly according to a plane containing said longitudinal axis of symmetry.

3. The winding device according to claim 1, wherein said ribs define longitudinal axes which are parallel with one another and with said longitudinal axis of symmetry of said frame and are positioned symmetrically relative to said longitudinal axis of symmetry of said frame.

4. The winding device according to claim 3, wherein said transversal elements are positioned symmetrically relative to the central axis of said frame, orthogonal to said longitudinal axis of symmetry, giving said frame a shape with double symmetry.

5. The winding device according to claim 3, wherein each of said first housings has a substantially U-shaped profile formed by the opposite inner surfaces of said ribs, comprised between the ends of said ribs and one of said transversal elements and constituting the sides of said U-shaped profile, and by the outer surface of one of said transversal elements, forming the base of said U-shaped profile.

6. The winding device according to claim 5, wherein each of said inner surfaces of said ribs is tapered according to a direction incident upon said longitudinal axis of each of said ribs.

7) (canceled)

8. The winding device according to claim 1, wherein said lowered zone has a main section with a constant profile and tapered ends.

9. The winding device according to claim 4, wherein it comprises rotation and support means for the user, consisting of:
a shaft removably inserted in through-holes coaxial with one another according to said central axis of said frame and made in each of said ribs;
a handle connected to a first end of said shaft.

10. The winding device according to claim 9, wherein at least one of said ribs has, at its lateral edge, at least one recess suitable to hold a projection present at least at one end of said handle for preventing rotation of said frame around said central axis in rest conditions.

11. The winding device according to claim 10, wherein said shaft has, on its lateral surface, at a second end opposite said first end, a pair of ring-shaped prominences projecting from said lateral edge of one of said ribs when said frame supports said cable in rest conditions, the innermost prominence being positioned close to a shoulder, made in each of said through-holes, to allow said frame to turn around said central axis.

12. The winding device according to claim 11, wherein said second end of said shaft has a diametral cut suitable to make it elastically yielding.

13. The winding device according to claim 9, wherein said shaft and said handle are made as a single body.

14. The winding device according to claim 1, wherein said frame is made of plastic material.

15. The winding device according to claim 14, wherein said plastic material contains fibreglass.
